(19) United States
(12) Patent Application Publication
(10) Pub. No.: US 2006/0053924 A1
(43) Pub. Date: Mar. 16, 2006

(54) Safety device for a vibratory plate

(76) Inventors: Jorg Antweiler, Ney (DE); Kurt Hickmann, Braunshorn (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/196,762

(22) Filed: Aug. 4, 2005

(30) Foreign Application Priority Data
Aug. 31, 2004 (DE) 102004042058.0

(51) Int. Cl. G05G 1/00

(52) U.S. Cl. 74/469

(57) ABSTRACT

A safety device for a vibratory plate have a drive lever. The drive lever includes an axle for adjusting at least one forward and one reverse travel direction. The safety device also includes a hydraulic cylinder having a piston rod that controls at least one exciter shaft. The safety device further includes a tappet coupled rigidly with the driver axle. The safety device also includes a connecting rod which can provide a coupling between the tappet and transmission lever. The safety device additionally includes a release lever which is displaceable such that the tappet and transmission lever can be decoupled.

The invention concerns a safety device for a vibratory plate with an oil column adjustment.

From the state of the art, vibratory plates are known that are used for soil compaction. Mostly two different systems are used for adjusting the travel direction of the plates. The first system uses a hydraulic oil column adjustment. In the second system, a mechanical adjustment is effected by means of traction. In the case of the oil column adjustment, a drive lever operates an adjusting cylinder by means of an oil column. The travel direction can be changed using the adjusting cylinder.

Since vibratory plates partly have very large weights, e.g., over 500 kg., very high safety requirements are necessary while handling these plates. It is particularly risky for an operator if a vibratory plate is operated in the reverse travel direction. In this case it should be possible for an operator to control the movement of a vibratory plate quickly and safely in the face of danger. An example of a device for the protection from vibratory plates moving in reverse travel direction is an emergency switch. It can be used to interrupt electrical or mechanical systems such that a plate, for example, that is moving in reverse travel direction can be stopped. The problem here is that operating an emergency switch does not necessarily eliminate the danger, instead probably only restricts it. If e.g., an operator is jammed in by a vibratory plate, he cannot be freed from this state by operating an emergency switch. Another reverse travel protective system is to pull or grab the levers provided, in a hazardous situation. The disadvantage here is that levers of this kind are probably not easily accessible in case of emergency and they neither eliminate nor restrict the danger. If a vibratory plate is used in which the travel direction is effected by means of a hydraulic oil column adjustment, the travel direction can be affected only if an associated adjusting cylinder is moved. However, this requires the operation of a lever that in a hazardous situation, as mentioned above, is sometimes not easily accessible.

Therefore the task of the invention is to create a device for a vibratory plate in which the travel direction can be adjusted by means of a hydraulic oil column with which the travel direction can be easily, safely and quickly adjusted in a hazardous situation.

In accordance with the invention this task is solved by using a device for a vibratory plate that has: a drive lever with a drive lever axle for adjusting at least one forward and one backward travel direction, a piston rod of a hydraulic adjusting cylinder with which at least one exciter shaft can be controlled for an imbalance of mass, wherein a tappet is rigidly coupled with the drive lever axle, a transmission lever is coupled with the drive lever axle with clearance-fit, a connecting rod is provided with which the tappet and the transmission lever can be coupled, where in the coupled state of tappet and transmission lever, the tappet is connected via the transmission lever with a piston rod of the hydraulic adjusting cylinder and a release lever is provided with which the connecting rod can be positioned such that the tappet and the transmission lever are decoupled from each other.

This is advantageous because by the decoupling of a tappet from a transmission lever, there is no longer a connection between tappet and the piston rod. Thus the parts that are crucial for determining a travel direction are separated from each other.

In an advantageous embodiment of the invention, in the decoupled state of tappet and transmission lever, the piston rod can be freely moved and a travel direction of the vibratory plate can thus be changed. This is advantageous because in the decoupled state of tappet and transmission lever, the piston rod that is necessary for an oil column adjustment of an adjusting cylinder no longer has to remain in its previously occupied position.

If the vibratory plate is operated in its reverse travel direction and if the transmission lever is no longer in a position to transfer a force on the piston rod of the adjusting cylinder, then in the case of a thus operated machine, the preferred running direction, for example, the forward travel direction is immediately effected by means for the imbalance masses. By the decoupling of the tappet and the transmission lever it is possible to reliably change the travel direction into the preferred running direction.

In an advantageous embodiment of the invention, in the decoupled state of tappet and transmission lever, the connecting rod and the transmission lever are in a coupled state. This is advantageous because thus the connecting rod occupies a defined position that is independent of the release lever. Since the transmission lever is connected to the drive lever axle only with clearance fit and not rigidly, the transmission lever also cannot transmit any force onto the piston rod such that the connecting rod that is connected with the transmission lever can no longer transfer a movement of the tappet that is rigidly connected with the drive lever axle.

In accordance with a preferred embodiment of the invention, the decoupled state of tappet and transmission lever is possible during a reverse travel direction of the vibratory plate. This is advantageous because it provides protection during reverse travel. The reverse direction of travel poses a particular risk to the operator towards whom in this case the vibratory plate moves.

In accordance with another embodiment of the invention, the freely moving piston rod can be displaced into a position in which the vibratory plate either stops or moves in forward travel direction. This is advantageous because thus in the particularly dangerous reverse travel it is possible to interrupt the travel or change the travel direction thus into forward travel direction. The standstill of the machine restricts an increase of the danger whereas changing into a forward travel direction reduces the danger.

In accordance with another embodiment of the invention, the release lever can be positioned by means of a pressure element. This is advantageous because a pressure element can be easily activated during danger and increases safety in an advantageous arrangement on the vibration plate. However, in principle, it is also possible to activate the release lever directly.

In accordance with another embodiment of the invention, in the decoupled state between the tappet and the transmission lever, the instantaneous driving condition cannot be changed in the case of activation of the drive lever. This is advantageous because the safety is additionally increased, in that in a hazardous situation, the changed travel direction is retained unchanged. In a vibratory plate moving in a reverse travel direction, this means, that by means of the device in accordance with the invention, a further reverse travel is impossible. This applies even in the case of an unintentional operation of the drive lever in a hazardous situation.

In accordance with another design of the invention, in the decoupled state of tappet and transmission lever after displacing the drive lever in a highest-level forward travel direction position, the tappet and the transmission lever can be brought again into the coupled state. This is advantageous because in the decoupled state of tappet and the transmission lever, the travel direction cannot be affected, except when the drive lever is displaced in a highest-level forward travel direction position. If this is carried out unintentionally in a hazardous situation, the tappet and transmission lever couple again and the vibratory plate is operated in forward travel direction, due to which the danger for the operator is reduced. In addition, a coupled state is again possible by this measure after the deliberate decoupling of tappet and transmission lever so that the device is again activated to prevent a hazardous situation.

In accordance with yet another embodiment of the invention, each transmission lever is arranged on two opposite sides of the tappet. This is advantageous because thus the force for moving the connecting rod can be applied from two sides of the connecting rod.

In accordance with another embodiment of the invention, the transmission levers that are arranged on two opposite sides of the tappet have a one-piece connection with each other. This is advantageous because an operating force has to be applied only into one transmission lever, the effect of the force is however carried further by both the transmission levers.

In accordance with another embodiment of the invention, the transmission levers that have a one-piece connection to each other encompass the tappet in the form of a fork. This is advantageous because thus a symmetrical structure is possible and the force for moving the connecting rod can be applied symmetrically.

In the following description the invention is explained more elaborately on the basis of preferred embodiments and with reference to the drawing. The figures in the drawing illustrate:

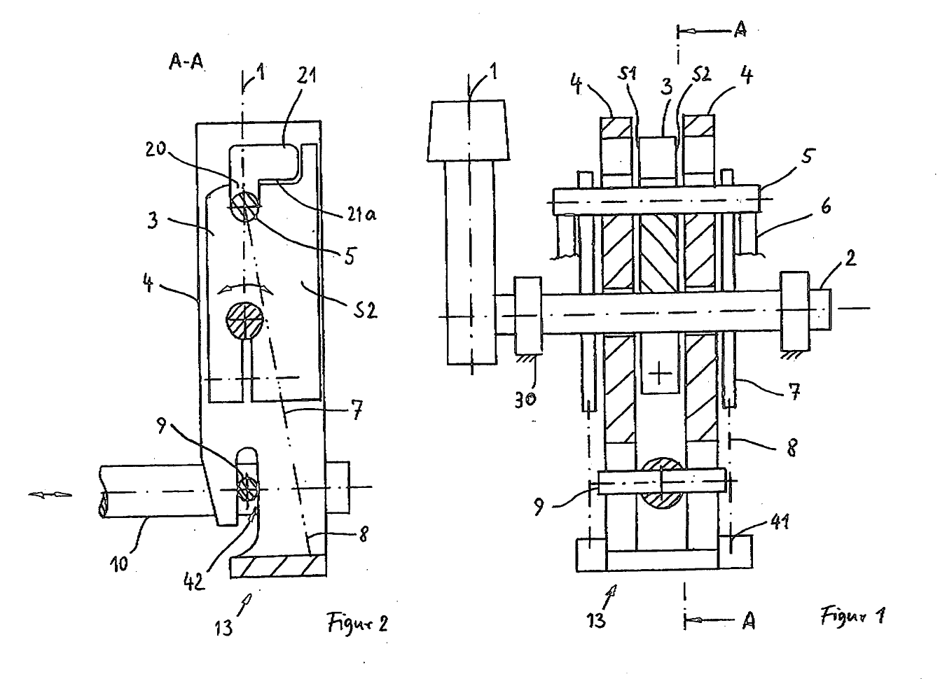

FIG. 1 a front view of an embodiment of the device in accordance with the invention;

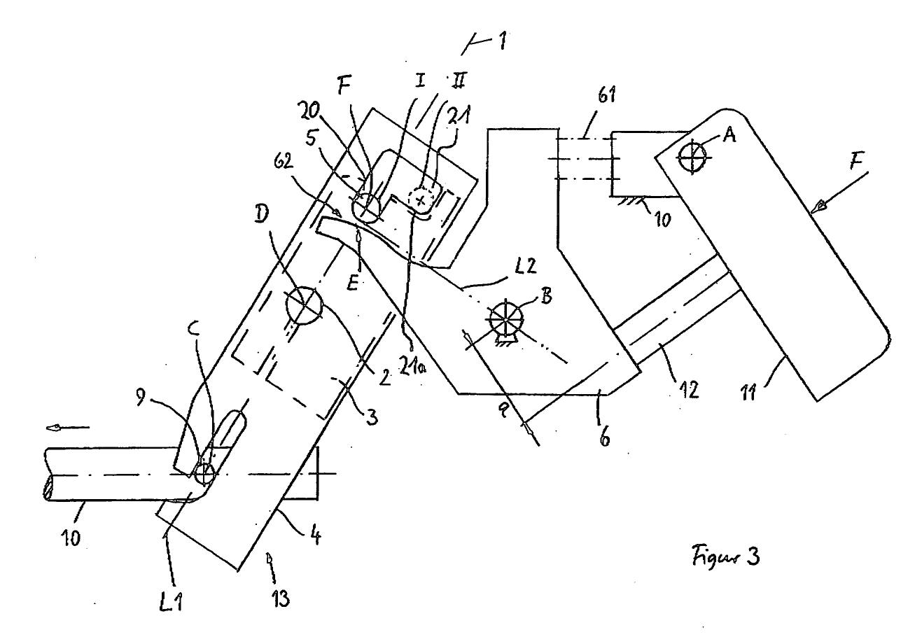

FIG. 2 a sideview of the embodiment illustrated in FIG. 1 of the device in accordance with the invention;

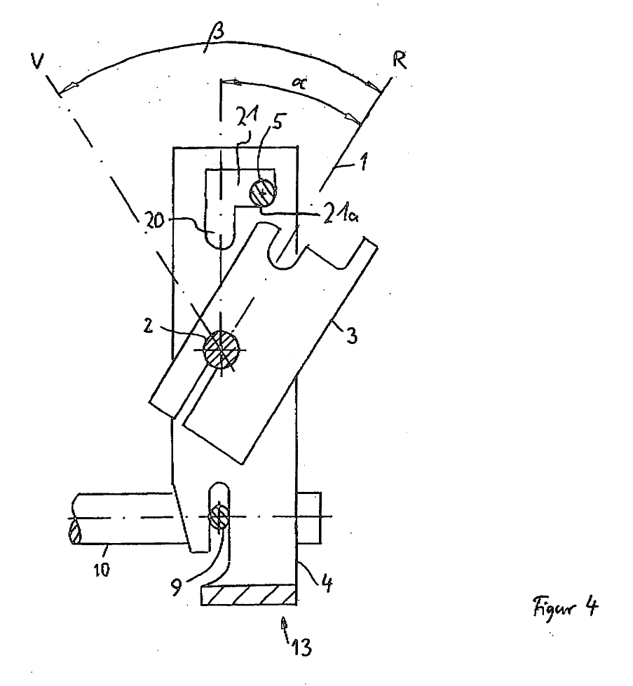

FIG. 3 a sideview of an embodiment of the invention in reverse travel position in a first state; and

FIG. 4 a sideview of an embodiment of the invention in accordance with the invention in a second state.

The same reference symbols are used for the same parts in the figures.

FIG. 1 illustrates a schematic illustration of the device in accordance with the invention. As can be seen in FIG. 1, a drive lever 1 is connected with a drive lever axle 2 that is supported for example in a housing 30. A tappet 3 is coupled so rigidly with the drive lever axle 2 such that either a form fit and/or a force fit exists between both components. A transmission lever 4 is arranged adjoining the tappet 3 that does not directly touch the tappet 3. In the embodiment illustrated in the FIG. 1, each transmission lever 4 is arranged both to the left of the first flat side SI of the tappet 3, and also to the right of the second flat side S2 of the tappet 3 where the first flat side S 1 lies opposite to the second flat side S2. In this embodiment the transmission levers have a one-piece connection with each other such that the tappet 3 is encompassed in the form of a fork 13. The transmission lever 4 is mounted on the drive lever axle 2 where there is no rigid connection between the transmission lever 4 and the drive lever axle 2. The transmission lever 4 can be connected on the drive lever axle 2 with a clearance fit or a still larger fit. During the activation of the drive lever 1 thus the drive lever axle 2 is also activated due to which the tappet 3 swivels around the drive lever axle 2. Since there is no form fit or force fit between the drive lever axle 2 and the transmission lever 4, the transmission lever 4 does not swivel when the drive lever 1 is activated around the drive lever axle 2.

Furthermore, in the embodiment of the device in accordance with the invention that is illustrated I FIG. 1, a connecting rod 5 is provided that acts as a coupling element between the tappet 3 and the transmission lever 4. For this purpose, the connecting rod 5 is inserted in a depression 20 of the tappet 3 and of the transmission lever 4 (refer to FIG. 2). Thus a form-fit connection exists between the tappet 3 and the transmission lever 4. The connecting rod 5 is provided on both ends with a connecting device 7 that is connected via a tension spring 8 with each of the transmission levers 4 on the fixing position 41. The connecting rod is thus pushed using the tension spring 8 into the depression 20 of the tappet 3 and the transmission lever 4 so that additionally, a force fit exists between the connecting rod 5 and the transmission lever 4 and/or the tappet 3. The tension spring 8 can also be directly connected with the connecting rod 5 without the connecting device 7 and without effecting a change of the force fit between the connecting rod 5 and the tappet 3 and/or the transmission lever 4. However, the connecting device 7 is provided due to the narrow space in the area of the drive lever axle and because the tension spring 8 can collide with the drive lever axle 2 in case of different positions of the tappet 3 and the transmission lever 4. Thus the connecting device 7 acts as a deviation of force. FIG. 2 illustrates the direct line of force between the connecting rod 5, connecting device 7 and the tension spring 8 in the form of a dotted line.

Furthermore, the transmission lever 4 is provided with a guide 42, (refer to FIG. 2) with which a bolt 9 can be led to a piston rod 10 of an adjusting cylinder. The bolt 9 is connected rigidly with the piston rod 10. If the drive lever 1 is operated, for example, if it swivels, the drive lever axle 2 and with it the tappet 3 also swivel. By means of the connecting rod 5 that connects the tappet 3 with the transmission lever 4 in a form and force fit, a swivel force applied via the drive lever 1 and the transmission lever 4 to the bolt 9 of the piston rod 10. Since the piston rod 10 can be moved in longitudinal direction in an adjusting cylinder, the swiveling of the drive lever 1 is further transmitted via the transmission lever 4 and its guide 42 to the adjusting cylinder. Thus the swiveling of the drive lever 1 is converted into a parallel movement of the piston rod 10. The position of the parts with respect to each other, illustrated in FIG. 1, corresponds to a position in the idling or standstill of the vibratory plate.

FIG. 3 illustrates a position of the parts of the device in accordance with the invention during reverse direction of the vibratory plate. For this purpose, the drive lever 1 swivels to the right, due to which in the coupled state of tappet 3 and the transmission lever 4, both the tappet 3 as well as the transmission lever 4 occupy a position that deflects to the right, where the parts swivel around the centerline D of the drive lever axle 2 in clockwork direction. For this purpose, the bolt 9 slides into the guide 42 of the transmission lever 4 in such a manner that the piston rod 10 is displaced toward the right.

Moreover, FIG. 3 illustrates the release lever 6. It is held in a rest position by means of a pressure spring 61 such that it swivels around the axis B fixed to the housing. If a pressure force is exerted on a pressure element 11 for example a pushbutton that swivels around the axis A, then this pressure force is transmitted via the pusher 12 onto the release lever 6. By means of the pressure force, a momentum is applied via the lever arm a around the axis B, that leads to a swiveling of the release lever 6 in clockwise direction. The release lever 6 is provided with a cam track 62 that after a few degrees of swiveling of the release lever 6, moves the connecting rod 5 out of the depression 20 toward the direction of the recess 21.

Preferably, the point of force application E of the release lever 6 for the contact with the connecting rod 5 is placed in such a manner that it lies in line with the line L1 formed by the axes C, D and F. In a particularly advantageous embodiment of the invention, the line L2 that is formed from a connection between the point of force application E and the axis of rotation B of the release lever 6, is located vertical to the line L1. Thus the force for moving the connecting rod 5 into the recess 21 is used optimally where only minimum lateral forces occur, that push the connecting rod 5 to the edge of the depression 20.

Due to the swiveling of the release lever 6, the connecting rod 5 is displaced from a position I into a position II (refer to FIG. 3). The recess 21 has a shoulder 21a , (refer to FIG. 2) on which the connecting rod 5 rests after the swiveling of the release lever 6. The tappet 3 gets decoupled from the transmission lever 4 due to the displacement of the connecting rod 5 from the position I into the position II. The connecting rod 5 that rests on the shoulder 21a of the recess 21, thus does not couple the tappet 3 with the transmission lever 4 any more, such that the transmission lever 4 can no longer transmit any force to the bolt 9 of the piston rod 10 due to its clearance fit with the drive lever axle 2. The piston rod 10 is thus no longer held in its position, which is the reverse position in case of the situation illustrated in FIG. 3. Subsequently, the vibratory plate being operated immediately occupies its preferred running direction of the exciter that is either an idle run or forward position of the vibratory machine. This results in (refer to FIG. 4) the disengaging of the position of the transmission lever 4 from the position of the tappet 3 and in spite of a reverse position of the drive lever 1, the piston position for standstill or forward travel is achieved.

In a decoupled state of such type between tappet 3 and transmission lever 4, a movement of the drive lever 1 leads to a movement of the bolt 9 of the piston rod 10 only if the tappet 3 touches the connecting rod 5 that rests on the shoulder 21a of the transmission lever 4 and thus moves the transmission lever 4. If the preferred running direction of the hydraulic circuit of the vibratory plate leads to a standstill, such that the transmission lever 4 for example, is arranged vertical to the piston rod 10, then the driving condition of the vibratory plate does not change in case of a movement of the drive lever in the first angle range α, (refer to FIG. 4). If the preferred running direction of the vibratory plate is set at the forward direction, then the swiveling of the tappet 3 within the second angle range β does not result in a change in the driving condition of the vibratory plate. If the drive lever 1 is moved out beyond the second angle range β, for example, into a highest-level forward direction position, then the connecting rod 5 is pushed from the shoulder 21a in the direction toward the depression 20 and is pushed into the depression 20 by the connecting device 7 and the tension spring 8. This means, the connecting rod 5 reestablishes a coupling of the tappet 3 and the transmission lever 4. In such a coupled state, every swiveling movement of the drive lever 1 results in a translatory movement of the piston rod 10 and thus a change in the travel direction.

It should be pointed out here that the release lever 6 with its cam track 62 can be designed in such a manner that the connecting rod 5 decouples from the tappet 3 and the transmission lever 4 not only in the position R of the drive lever 1 (refer to FIG. 4). The function of the decoupling of the connecting rod 5 from the depression 20 can even occur if the drive lever 1 swivels into position V (refer to FIG. 3). In this case, the cam track 62 must be dimensioned in such a manner that the release lever 6 moves the connecting rod 5 out of the depression 20 by swiveling around the axis B.

The operation of the pressure element 11 and thus the release lever 6 interrupts a coupling of the tappet 3 and the transmission lever 4 such that a piston rod 10 of an adjusting cylinder for the travel position is no longer held in the default position and a preferred running direction can be adjusted in the hydraulic circuit. Thus only by operating a pushbutton 11, a travel direction can be adjusted in a device for a vibratory plate with a hydraulic oil column, wherein this operation is very simple, safe and fast to carry out.

1. Safety device for a vibratory plate, comprising that has:
a drive lever with a drive lever axle for adjusting at least one forward and one reverse travel direction,
a piston rod of a hydraulic adjusting cylinder with which at least one exciter shaft can be controlled for an imbalance mass, wherein,
a tappet is rigidly coupled to the drive lever axle,
a transmission lever which is coupled to the drive lever axle with clearance fit,
a connecting rod is provided with which a coupling between the tappet and the transmission lever is possible where in the coupled state of the tappet and the transmission lever, the tappet is connected via the transmission lever with a piston rod of the hydraulic adjusting cylinder, and
a release lever is provided with which the connecting rod is displaceable such that the tappet and the transmission lever are decoupled from each other.

2. Device in accordance with claim 1, in wherein while the tappet and transmission lever are decoupled from each other, the piston rod is freely movable and a travel direction of the vibratory plate can be changed.

3. Device in accordance with claim 1, wherein while the tappet and transmission lever are decoupled from each other, the piston rod and the transmission lever are in a coupled state.

4. Device in accordance with claim 1, wherein the decoupled state between tappet and transmission lever can be achieved only in a reverse travel direction of the vibratory plate.

5. Device in accordance with claim 2, wherein the freely moving piston rod is displaceable into a position in which a standstill or a forward travel direction of the vibratory plate is possible.

6. Device in accordance with claim 1, wherein the release lever can be positioned by means of a pressure element.

7. Device in accordance with claim 1, wherein while the tappet and transmission lever are decoupled from each other, the instantaneous driving condition cannot be changed during the operation of the drive lever.

8. Device in accordance with claim 1, wherein the decoupled state of tappet and transmission lever after displacing the drive lever into the highest-level forward travel position, the tappet and the transmission lever can be brought again into the coupled state.

9. Device in accordance with claim 1, wherein each transmission lever is arranged on two opposite sides of the tappet.

10. Device in accordance with claim 9, wherein the transmission levers have a one-piece connection with each other.

11. Device in accordance with claim 10, wherein the transmission levers encompass the tappet in the form of a fork.

12. Device in accordance with claim 1, wherein the connecting rod is resiliently pre-stressed in the direction of the coupling position.

13. Device in accordance with claim 12, wherein the resilient pre-stressing is applied to the connecting rod by means of a tension spring and that a connecting device is available for deviating the spring force.
